(19) United States
(12) Patent Application Publication
(10) Pub. No.: US 2026/0270738 A1
(43) Pub. Date: Sep. 10, 2026

(54) QOS-ADAPTIVE VOICE-OVER-WIFI SWITCHING

(71) Applicant: Telefonaktiebolaget LM Ericsson (publ), Stockholm (SE)

(72) Inventors: Ram KUMAR SHARMA, BANGALORE (IN); Pushpendra SHARMA, BANGALORE (IN); Sunil Kumar VUPPALA, BANGALORE (IN); Sumit SOMAN, BANGALORE (IN)

(73) Assignee: Telefonaktiebolaget LM Ericsson (publ), Stockholm (SE)

(21) Appl. No.: 19/165,895

(22) PCT Filed: Mar. 16, 2023
(86) PCT No.: PCT/IN2023/050250

§ 371 Date: Sep. 16, 2025

(51) Int. Cl. H04W 24/08; H04B 17/318; H04L 65/1016; H04W 36/30

(52) U.S. Cl. CPC H04W 24/08; H04B 17/318; H04L 65/1016; H04W 36/30

(57) ABSTRACT

A method by a core network function of a core network of a wireless communication network includes detecting that a user equipment, UE, that is connected to the wireless communication network is using an unlicensed radio access network to access an internet protocol media subsystem, IMS, voice telephony service using a packet data connection with a packet gateway in the wireless communication network, and monitoring a quality measurement of a voice connection of the UE that uses the packet data connection that is established over the unlicensed radio access network.

### TECHNICAL FIELD

The present application relates to wireless communication networks, and in particular, to wireless communication networks that support voice over WiFi (VoWiFi).

### BACKGROUND

Voice over WiFi (VoWiFi) is a service provided by mobile network operators (MNOs) that makes it possible for users to make regular voice calls from user equipment (UE) devices using an untrusted and/or trusted WiFi network in situations such as when cellular coverage is poor.

WiFi calling is closely aligned with a feature of Long Term Evolution (LTE) communication systems called Voice over LTE (VOLTE), and can be used as a complement to VOLTE. LTE is also sometimes referred to as E-UTRAN, or Evolved Universal Mobile Telephone System (UMTS) Radio Access Network. WiFi calling uses an internet protocol (IP) media subsystem (IMS) telephony client, and supports mobility between LTE and WiFi access, making the resulting user experience seamless.

A WiFi network used for VoWiFi could be untrusted, as it could be a public or home network, and may or may not be managed by a mobile operator. To have interworking of 3GPP network components with untrusted WiFi components, the third generation partnership project (3GPP) has defined a new entity referred to as the evolved Packet Data Gateway (ePDG) in the Enhanced Packet Core (EPC) network of an LTE network.

When accessing VoWiFi, the user creates a secure tunnel (IPsec) from the untrusted WiFi network to an ePDG in the EPC network. The ePDG authenticates the UE during tunnel setup with an AAA (Authentication, Authorization and Accounting) server. After the UE has been authorized and authenticated, the ePDG will establish a connection using General Packet Radio Service (GPRS) Tunnelling Protocol (GTP) tunneling over S2b interface with a packet data network (PDN) Gateway (PGW).

FIG. 1A illustrates an end to end (E2E) view of VoWiFi and VOLTE connections in a 3GPP defined EPC network, and FIG. 1B illustrates various interfaces used in a VoWiFi connection. In particular, as shown in FIG. 1A, a UE may connect to an EPC via a 3GPP network using VOLTE or via a network such as the Internet via VoWiFi. The EPC provides a connection to an IMS via a proxy call session control function (P-CSCF). As shown in FIG. 1B, an SWu interface is defined for communications between the WiFi access point (AP) and the ePDG. The ePDG communicates with the AAA server via a SWm interface, and with a PGW via an S2b interface.

FIG. 2 illustrates the logical location of the ePDG in a 3GPP EPC architecture. In particular, the ePDG resides at the edge of a public land mobile network (PLMN), such as an EPC/LTE network, and provides an interface for IP access to the PDN gateway by UEs and untrusted non-3GPP networks.

A seamless handover procedure has been defined between the LTE network and the untrusted WiFi access, and vice versa, so that session continuity can be provided without call drops during handover between LTE and WiFi networks.

VoWiFi is referred to as a “best effort service.” That is, VoWiFi will attempt to provide connectivity, but cannot guarantee and manage the end-to-end quality of service (QoS) that can be offered by 3GPP access using a VOLTE implementation.

For uplink packets, dynamic differentiated services code point (DSCP) mapping is implemented by QoS class identifier (QCI)-to-DSCP mapping, which is a dynamic mechanism to configure DSCP of packets sent from the interface according to the DSCP of other units on the network.

For downlink packets, the ePDG obtains a DSCP value from a GTP-U message, and sends the message to the UE.

Because WiFi coverage is localized in nature, the signal strength of a WiFi network, measured at the UE, may be higher than that of the 3GPP access network. In that case, a UE that is connected to the ePDG via WiFi will remain on WiFi unless an outage occurs or the UE moves out of range of the WiFi network.

### SUMMARY

A method by a core network function of a core network of a wireless communication network according to some embodiments includes detecting that a user equipment, UE, that is connected to the wireless communication network is using an unlicensed radio access network to access an internet protocol media subsystem, IMS, voice telephony service using a packet data connection with a packet gateway in the wireless communication network, and monitoring a quality measurement of a voice connection of the UE that uses the packet data connection that is established over the unlicensed radio access network.

The method may further include determining whether the quality measurement of the voice connection indicates that the voice connection has a low quality of service, and in response to determining that the voice connection has a low quality of service, reporting to a cellular radio access network in the wireless communication network that the voice connection has the low quality of service.

The method may further include receiving an indication from the radio access network that the UE should perform a handover of the voice connection to the cellular radio access network, and in response to the indication, requesting that the UE handover the voice connection to the cellular radio access network.

The core network function may be an evolved packet data gateway, ePDG. The core network may be an evolved packet core, EPC, network and the radio access network may be a long term evolution, LTE, radio access network.

Reporting to the cellular radio access network in the wireless communication network that the voice connection has the low quality of service may include reporting to a service management and orchestration function in the wireless communication network.

The quality measurement may include a measurement of packet loss, jitter, round trip time, received signal strength, traffic rate, traffic volume, packet drop rate and/or a measurement of latency of the voice connection.

The method may further include determining whether the quality measurement of the voice connection indicates that the voice connection has a low quality of service, and in response to determining that the voice connection does not have a low quality of service, periodically reporting information relating to the quality of service of the voice connection to a cellular radio access network in the wireless communication network.

The method of any previous Claim, wherein monitoring the quality measurement of a voice connection of the UE that uses the packet data connection that is established over the unlicensed radio access network includes monitoring a first quality measure and a second quality measure and comparing the first quality measure to a first threshold and the second quality measure to a second threshold.

The first quality measure may include packet loss and the second quality measure may include latency.

A method by a service management and orchestration entity that performs management of a radio access network is provided according to some embodiments. The method includes receiving, from a core network function of a core network, information regarding a call quality of a voice connection of a UE that is connected to the radio access network, wherein the voice connection uses an unlicensed radio access network to access an IMS voice telephony service using a packet data connection with a packet gateway in the core network that carries the voice connection, and determining whether or not to request a handover of the voice connection to the radio access network in response to the information.

Determining whether or not to request a handover of the voice connection to the radio access network may include determining whether the quality of the voice connection is less than a critical threshold quality level.

Determining whether or not to request a handover of the voice connection to the radio access network may further include determining whether an expected quality of the voice connection after handover to the radio access network is greater than an acceptable threshold quality level.

The method may further include transmitting an indication to the core network function that the UE should handover the voice connection to the radio access network.

The method may further include, in response to receiving the information, subscribing to call quality information relating to the call, and continuing to monitor the call quality of the voice connection.

The method may further include instructing the UE to override a setting of “always prefer WiFi to cellular” for packet data voice connections in response to the call quality of the voice connection.

The method may further include, in response to determining that the quality of the voice connection is greater than the critical threshold quality level or determining that the expected quality of the voice connection after handover to the radio access network is less than the acceptable threshold quality level, comparing a signal strength of a signal transmitted from the radio access network to the UE to a third threshold, and, in response to determining that the signal strength of the signal transmitted from the radio access network to the UE is less than the third threshold, allowing the UE to continue the voice connection using the unlicensed radio access network.

The method may further include, in response to determining that the signal strength of the signal transmitted from the radio access network to the UE is greater than the third threshold, transmitting an indication to the core network function of the core network to cause the UE to handover the voice connection to the radio access network.

The method may further include comparing a load measure of the voice connection over the unlicensed radio access network to a fourth threshold and comparing a packet loss measure of the voice connection over the unlicensed radio access network to a fifth threshold. The method may further include, in response to determining that the signal strength of the signal transmitted from the radio access network to the UE is greater than the third threshold, that the load measure is lower than the fourth threshold, and that the packet loss measure is lower than the fifth threshold, transmitting an indication to the core network function of the core network to cause the UE to handover the voice connection to the radio access network.

A network node according to some embodiments includes processing circuitry configured to perform any of the foregoing operations, and power supply circuitry configured to supply power to the processing circuitry.

A wireless communication system according to some embodiments includes a core network function of a core network of the wireless communication system, and a service management and orchestration, SMO, entity that manages a radio access network of the wireless communication system. The core network function detects that a user equipment, UE, that is connected to a radio access network of the wireless communication network is using an unlicensed radio access network to access an internet protocol media subsystem, IMS, voice telephony service using a packet data connection with a packet gateway in the core network, monitors a quality measurement of a voice connection of the UE that uses the packet data connection that is established over the unlicensed radio access network. determines whether the quality measurement of the voice connection indicates that the voice connection has a low quality of service, and in response to determining that the voice connection has a low quality of service, reports to a cellular radio access network in the wireless communication network that the voice connection has the low quality of service. The SMO receives, from the core network function, an indication that the voice connection has the low quality of service, and determines whether or not to request a handover of the voice connection to the radio access network in response to the indication.

### BRIEF DESCRIPTION OF THE DRAWINGS

FIG. 1A illustrates an end to end (E2E) view of VoWiFi and VOLTE connections.

FIG. 1B illustrates various interfaces used in a VoWiFi connection.

FIG. 2 illustrates a logical location of an evolved packet data gateway (ePDG) in a 3GPP Evolved Packet Core (EPC) architecture.

FIG. 3 illustrates operations for establishing an IP Multimedia Subsystem (IMS) session for Voice-over-WiFi.

FIG. 4 illustrates an open RAN (O-RAN) system architecture for implementing systems/methods according to some embodiments.

FIGS. 5A and 5B illustrate a process flow according to some embodiments.

FIG. 6 illustrates a procedure for network data analytics function (NwDAF) data analytics subscription by a network function (NF) consumer.

FIG. 7 illustrates an Service Management & Orchestration (SMO) framework.

FIG. 8 illustrates international mobile subscriber identity (IMSI) information being used during call setup in the network access identifier (NAI) format.

FIG. 9 is a functional block diagram of a user equipment (UE) that obtains voice telephony services from an IP multimedia subsystem (IMS).

FIG. 10 shows an example of a communication system in accordance with some embodiments.

FIG. 11 shows an example of a UE in accordance with some embodiments.

FIG. 12 shows an example of a network node in accordance with some embodiments.

FIG. 13 shows an example of a host node in accordance with some embodiments.

FIG. 14 is a block diagram illustrating a virtualization environment in which functions implemented by some embodiments may be virtualized.

FIG. 15 shows a communication diagram of a host communicating via a network node with a UE over a partially wireless connection in accordance with some embodiments.

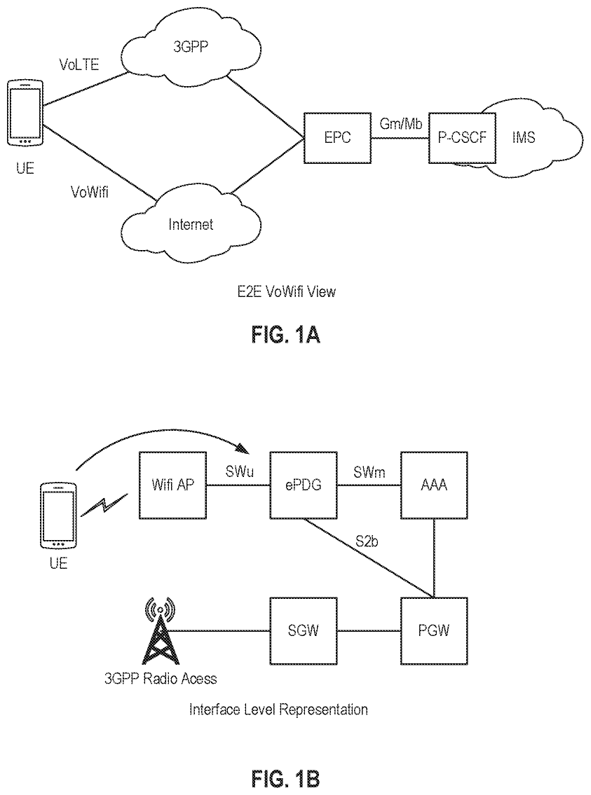

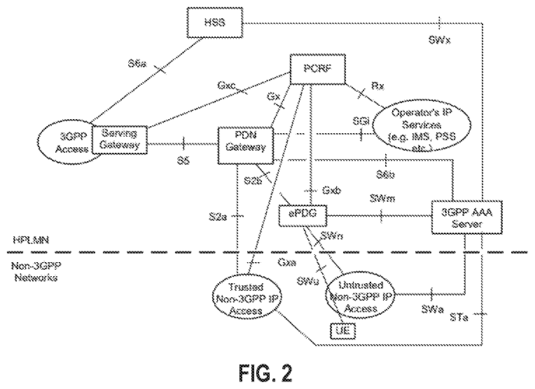

### DETAILED DESCRIPTION OF EMBODIMENTS

There currently exist certain challenges associated with the interworking of VoWiFi services and radio access network (RAN) connectivity. VoWiFi enables mobile network operators to quickly and easily extend their coverage or service range without costly RAN infrastructure deployment. Although VoWiFi may help to offload traffic from the cellular network and/or extend the coverage of the cellular network, there are occasions when VoWiFi cannot match the guaranteed services offered by the cellular network.

The 3GPP has defined a reference architecture for VoWiFi access that specifies procedures for policy control, charging, authentication, and handover between untrusted and trusted access infrastructures. However, QoS control remains a concern, especially for voice services.

Because VoWiFi uses a shared internet path, the end-to-end QoS of a VoWiFi connection can be impaired by congestion in a WiFi access or internet protocol (IP) network, and/or by high packet loss or high latency in the path. Unlike 3GPP access in which a voice IP connection is given high a high priority QoS Class Identifier, namely QCI 1, to prioritize the connection, VoWiFi does not have a mechanism to enforce the QoS of a call, and thus, as noted above, VoWiFi only provides a “best-effort” service.

When enabling VoWiFi in a UE, the service may be marked or set as a default voice service based on the availability of a WiFi access point. Even in scenarios in which voice quality is poor and the subscriber encounters problems such as call muting, one way audio, long call setup times, etc., the voice signal will be carried over the VoWiFi connection and may not be switched to a cellular network.

There is currently no mechanism for comparing the call quality of VoWiFi versus the call quality of VOLTE. Accordingly, choosing the best network to use for a call may be difficult. Moreover, 3GPP and non-3GPP networks do not share performance indicators with each other. For example, the ePDG and the radio access network (or RAN, which includes elements such as eNodeBs in an LTE network) do not communicate with each other.

Some embodiments described herein may provide solutions to these or other challenges. Some embodiments use a Service Management & Orchestration (SMO) entity based on an open radio access network (O-RAN) architecture to provide QoS control of VoWiFi connections. The SMO contains enrichment information (EI) functionality, which can subscribe to external entities to obtain source information. This functionality is not inherent to the access system of a 3GPP network, which requires an external EI termination and an external EI interface.

According to some embodiments, an SMO can subscribe to ePDG to obtain performance indicators at a predefined frequency or upon request. Together with cellular access-inherent data, (e.g., O1 corresponding to Control Unit (CU)/Distributed unit (DU)), the EI can be utilized by a non-real time RAN intelligent controller (RT RIC) to train a ML model to evaluate link quality in both WiFi and LTE access systems. A RAN Intelligent Controller (RIC) is a software-defined component of the Open Radio Access Network (Open RAN, or O-RAN) architecture that is responsible for controlling and optimizing RAN functions.

A near-RT RIC contains a UE database and an E2 node database, which can be used to identify a specific UE. Measurement information for a UE can either be passed on to a non-RT RIC or can be locally used to perform inference based on EI received via an A1 interface and E2 node performance measurements.

Based on comparison of the statistics of voice performance to various thresholds, or in case of a link break between the UE and the ePDG, the SMO may direct the ePDG to ask a UE to override the setting of “always prefer WiFi for voice” by executing a handover (HO) to a cellular access network. Such statistics may include, for example, values such as real-time transport protocol (RTP) packet loss and call setup time. The thresholds may include various E2 (CU/DU) node side qualifying thresholds, such as signal strength threshold, load threshold, and packet loss threshold.

After the UE setting of “always prefer WiFi for voice” has been overridden, the ePDG will discard subsequent voice call (VoWiFi) requests for a certain time for those UEs, so that the UEs will have a cellular access preference for new calls.

For ongoing calls, based for example on call performance, an RTP observation window may be defined at the ePDG side. The ePDG will determine if there is any RTP packet loss for a continuous period of n ms or r packets, which may indicate a mute call. In general n=160 ms and r=8 RTP packets.

Observations may be carried out based on RTP packet sequence number. On any such observations, the ePDG will report such occurrence to the SMO, and based on SMO feedback regarding the 3GPP access system performance, the ePDG will ask the UE to have a forced HO from VoWiFi to VOLTE.

Similar actions will be carried based on latency and jitter as well.

The UE will maintain a setting of “3GPP access preferred” until the next observation of WiFi performance becomes better than the defined thresholds, which will be reported by ePDG.

Accordingly, some embodiments provide voice call quality monitoring and comparison using RTP/real time transport control protocol (RTCP) over VoWiFi and VOLTE (or VoNR in the case of a New Radio, or NR, communication system), and proactively identify issues, such as muting, high latency, jitter, etc. This may help to determine which access system (e.g., WiFi or cellular access) is best suited for use by the UE to establish or maintain a call. The systems/methods may then redirect the call to a suitable path by overriding a setting, such as “always prefer WiFi.”

Some embodiments may also provide a mechanism to mitigate a tendency to maintain a persistent WiFi connection even in case of poor WiFi performance.

Some embodiments may also provide an algorithm to monitor VoWiFi vs VOLTE call performance, and provide automatic selection of radio access technologies (RATs) to improve user experience.

Some embodiments address an issue that arises because when WiFi is always preferred by a UE despite poor voice call experience, a call may not be transferred to a cellular (e.g., 3GPP) access system unless WiFi is unavailable. A comparative evaluation mechanism is not in place in standard architecture which can decide the preferred access system in case both VoWiFi and VOLTE connections are available. Some embodiments therefore provide a direct interface between the ePDG and a radio access network to enable such a mechanism.

Certain embodiments may provide one or more of the following technical advantage(s). Systems and/or methods described herein provide a framework that enables communication between a cellular access system and an ePDG using standard interfaces. Systems and/or methods described herein may be scalable and flexible, as modular machine learning (ML) applications may be employed to select, based on conditions, the best suited access system for a user. Selecting the best access system for a particular call may result in better quality of experience (QoE) and/or fewer call drops.

Some embodiments may enable MNOs to have QoS enforcement on voice calls, which may result in better control over VoWiFi services in the network.

Some of the embodiments contemplated herein will now be described more fully with reference to the accompanying drawings. Embodiments are provided by way of example to convey the scope of the subject matter to those skilled in the art.

According to some embodiments, performance monitoring information related to link quality status are provided to the SMO from the ePDG. Such information may include performance statistics and/or performance metrics, such as packet loss, latency, jitter, round trip time (RTT), measurement window, received signal strength, traffic rate, traffic volume, packet drop rate, etc. Link quality information can be provided by ePDG to SMO either directly or by notifying SMO to subscribe for required information from a network data analytics function (NwDAF).

On a needed basis, the ePDG can transfer the performance monitoring information to SMO using an Enrichment Information termination interface. This interface is open for implementation and may be proprietary or open.

In some embodiments, the SMO may obtain the performance monitoring information in response to a notification from ePDG to obtain the performance monitoring information from NwDAF by subscription.

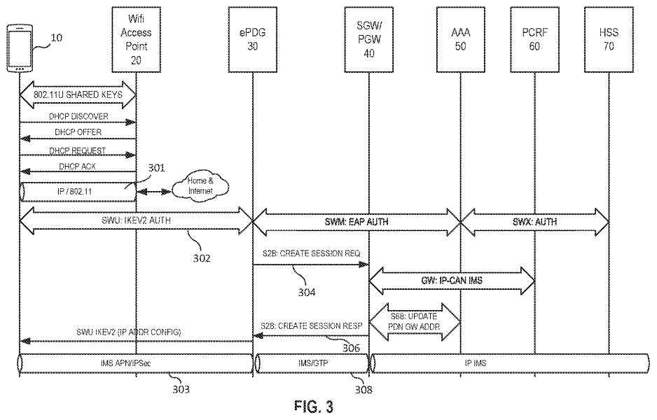

FIG. 3 illustrates operations for establishing an IMS session for VoWiFi. As shown in FIG. 3, in an existing setup, a VoWiFi capable UE 10 first identifies the WiFi availability and sets up an IP connection 301 to a WiFi access point 20. The UE 10 can then select an ePDG 30 either statically or based on a DNS query. In case of selection based on static definition, the UE can be statically provisioned with the IP addresses of available ePDGs.

For DNS based selection, the UE 10 can will reach out to the WiFi Access point 20 (AP) to identify a domain name server (DNS) service address. The UE 10 then queries the DNS server, which provides a list of ePDGs addresses to the UE 10. The UE 10 then selects an ePDG 30 from the list of available ePDGs.

To initiate a VoWiFi call, the UE 10 first needs to be authenticated to the home subscriber service 70 in the core network (step 302). Once the authentication is done, an IPSec tunnel 303 will be set up between the UE 10 and the selected ePDG 30.

After establishment of the IPSec tunnel 303, a PDN connection can be established to a packet gateway (PGW) 40 over an S2b interface with an IMS access point name (APN). A default bearer will be setup for this PDN connection, and the UE 10 will obtain an IP address from the PGW 40.

The ePDG sends a Create Session Request message (304) to the PGW 40. The message contains the user international mobile subscriber identity (IMSI), the IMS APN, the ePDG identity as Tunnel-Endpoint Identifier (TEID), the PDN Type, the PDN address, and the evolved packet system (EPS) bearer ID.

After obtaining information needed for session establishment from a policy and charging rules function (PCRF) 60 and an authentication, authorization and accounting function (AAA) 50, the PGW 40 sends a Create Session Response message (306) to the ePDG, which includes the IP address that has been allocated to the UE 10.

Finally, the S2b GTP tunnel 308 is established. For S2b, the UE establishes a separate SWu instance (i.e., a separate IPSec tunnel 303) for each PDN (APN) connection towards the ePDG 30.

A SWu instance (i.e., an IPSec tunnel) transports the packets of all S2b bearer(s) for the same PDN (APN) connection between the UE 10 and the ePDG 30.

The S2b tunnel 308, together with the IPsec tunnel 303, enables the anchoring of the session in the operators' PGW 40 through an unmanaged WiFi network. Once this step is finished, the SIP client of the UE 10 can now register the device with the IMS network for accessing WiFi Calling services.

The ePDG applies a traffic flow template (TFT) filter to direct uplink traffic to the correct S2b bearer. In the 3GPP specification, an Access Traffic Steering, Switching and Splitting (ATSSS) framework is proposed. The ATSSS enables a multi-access protocol data unit (PDU) connectivity service, which can exchange PDUs between the UE and a data network by simultaneously using one 3GPP access network and one non-3GPP access network.

The service provider can configure ATSSS rules and push them to the device via the 5GC core network. These rules determine how the device should utilize the 3GPP and non-3GPP access networks, specifically with respect to sending uplink traffic. For downlink traffic, based on rules, a User Plane Function (UPF) decides which access network should be used for which traffic flow.

To support ATSSS, a mandatory requirement is to a have a 5GC core network along with UE device support for ATSSS. This puts a compatibility limitation on many of existing devices using VoWiFi. Apart from this, the steering modes proposed in 3GPP are “Active-Standby”, “Smallest Delay”, “Load Balancing” or “Priority-based”. “Smallest delay” will try to first test the path latency and select the path with the smallest delay. However, this happens during call initiation. Although the initial path characteristics could be good, as the call progresses, the characteristics may degrade. The ATSSS may not consider that degradation as part of multi quality assessment, because the path is chosen based on latency only.

In a scenario where deployment of ATSSS is not homogeneous in a PLMN/slice (i.e., some network functions, NFs, in a PLMN/slice may not support ATSSS) multi-access PDU Sessions can be released due to UE mobility. For example, due to mobility, a UE may move from being served by a source AMF supporting ATSSS to a target AMF not supporting ATSSS. In that case, the multi access PDU Session may be released, and the call may be dropped.

Some embodiments described herein may overcome this limitation and offer a more backward compatible approach which does not put any compatibility requirement on the UE or the network.

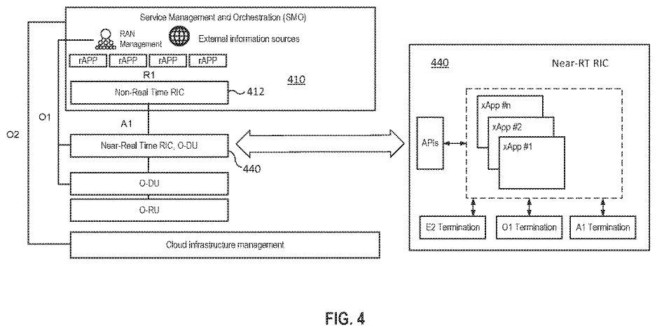

An open RAN (O-RAN) system architecture for implementing systems/methods described herein is illustrated in FIG. 4. The O-RAN Alliance defines O-Cloud as a cloud computing platform comprised of a collection of physical infrastructure nodes that meet O-RAN requirements to host the relevant O-RAN functions, the supporting software components, and the appropriate management and orchestration functions.

Referring to FIG. 4, O-RAN defines a service management and orchestration (SMO) function 410 that includes a non-real time RAN intelligent controller (RIC) 412.

The non-RT RIC 412 enables non-real-time control and optimization of RAN elements and resources. The non-RT RIC 412 can perform artificial intelligence (AI) and machine learning (ML) workflows including model training and updates, and perform policy-based guidance of applications/features in a Near-RT RIC 440 using an A1 Interface, which is between the Non-RT RIC 412 in the SMO and the Near-RT RIC 440, for RAN Optimization. The functionality of the Non-RT RIC 412 is directly responsible for driving what is sent and received across the A1 interface. The Non-RT RIC 412 allows applications to run on it. These applications are called “rApps”, where ‘r’ stands for RAN. The Non-RT RIC 412 exposes the SMO Framework functions to “rApps” via a set of “rApps” Services Exposure functions over the R1 interface. The R1 interface is the only interface between an “rApps” and the functionality of the Non-RT RIC 412 and the SMO 410, and is defined to meet all functional needs of rApps.

The Near-RT RIC 440, which is shown in more detail on the right side of FIG. 4, is a logical function that enables near-real-time control and optimization of RAN elements and resources via fine-grained data collection and actions over an E2 interface. The E2 interface enables a direct association between “xApps” running in the Near-RT RIC 440 and the RAN functionality. The Near-RT RIC 440 controls RAN elements, such as a distributed units (O-DU) and radio units (O-RU) in a radio access network via an O1 interface.

Some embodiments described herein can be implemented in an SMO 410 using rApp functionality for long term monitoring and/or in a Near-RT RIC 440 using xApp functionality.

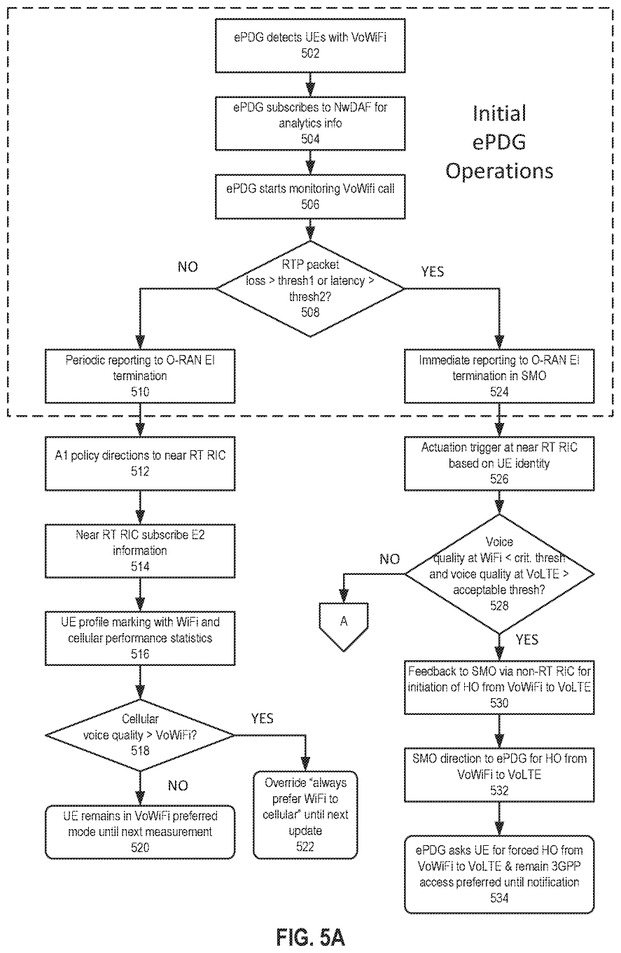

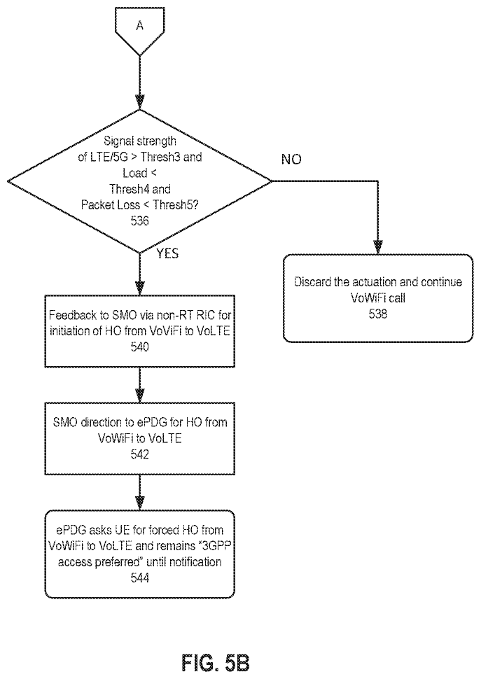

FIGS. 5A and 5B illustrate a process flow according to some embodiments. A single ePDG 30 may be connected to multiple UEs 10 via number of WiFi access points (APs) 20. As shown in FIG. 3, the ePDG 30 may have awareness of ongoing VoWiFi calls based on an end-to-end session which is combination of an IPsec tunnel 303 and a GTP tunnel 308.

Referring to FIGS. 3, 4 and 5A, an ePDG 30 detects that a UE 10 is using VoWiFi (block 502). The ePDG 30 starts monitoring ongoing VoWiFi call performance of the UE 10, either using existing performance monitoring functionality in the ePDG 30 or by subscribing to a NwDAF for analytics related information. The ePDG can act as consumer network function for NwDAF to get the required data.

The ePDG 30 may use information such as call identification (ID), mobile station ID, received signal strength, traffic rate, traffic volume, input packets, output packets, input packets dropped, output packets dropped, total packets lost during a window, round trip time (RTT), etc., to determine the link quality status on WiFi route. Such information may be obtained, for example, by subscribing to an NwDAF (block 504).

The ePDG 30 then starts to monitor the quality of the VoWiFi call at block 506.

At block 508, the ePDG 30 compares the RTP packet loss associated with the VoWiFi call to a first threshold (thresh1) and compares the latency of packets in the VoWiFi call to a second threshold (thresh2). If the ePDG 30 observes that consecutive RTP packet loss>thresh1 in a certain measurement window (e.g., RTP packet loss for continuous 160 ms or 8 RTP packets can be determined not be a mute call event) or if observed latency>thresh2, then such occurrences will be immediately reported to the SMO 410 at block 524 using an external EI termination. The thresholds thresh1 and thresh2 are configurable values.

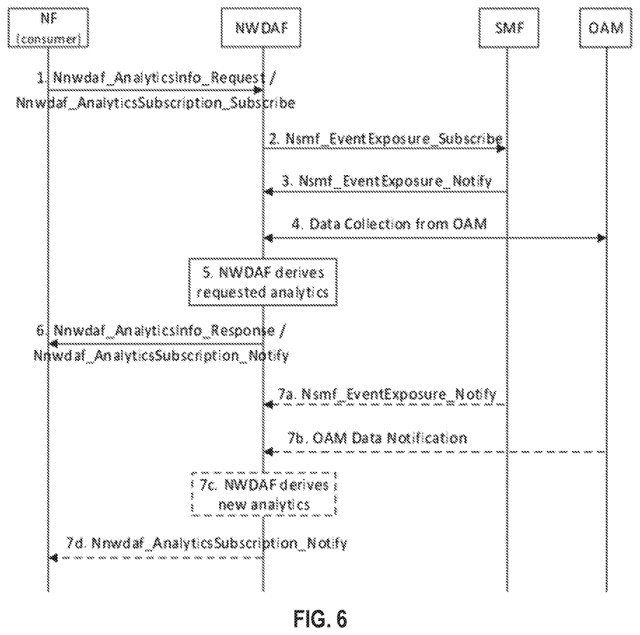

The SMO 410 either can consume the data directly from the ePDG 30 using an external enrichment termination or based on a ePDG alert. Brief reference is made to FIG. 6, which illustrates a procedure for NwDAF data analytics subscription by a NF consumer. By following the operations of FIG. 6, a NF such as SMO can subscribe to data analytics provided by a NwDAF.

Communication between the SMO 410 and the ePDG 30 could also be facilitated using external enrichment termination interface via open application programming interfaces (APIs).

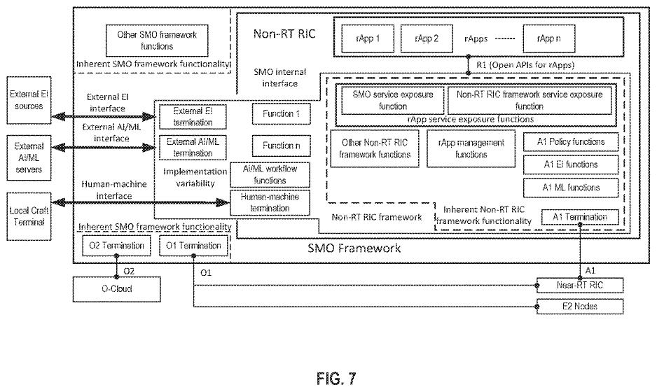

Brief reference is made to FIG. 7, which illustrates an SMO framework in detail. In case the SMO 410 subscribes to a NwDAF, it follows O-RAN alliance guidelines, in which an A1-EI/ML (A1 interface enrichment information/machine learning information) has close association with a 3GPP MDAS (management data analytics service).

The MDAS provider is expected to provide data analytics reports and recommendations to the consumers, such as core network (CN) or RAN functions or elements, leveraging data analytics and machine learning technologies.

The SMO 410 can utilize this data for long term modelling as well as evaluation of cellular network access for a provided UE 10.

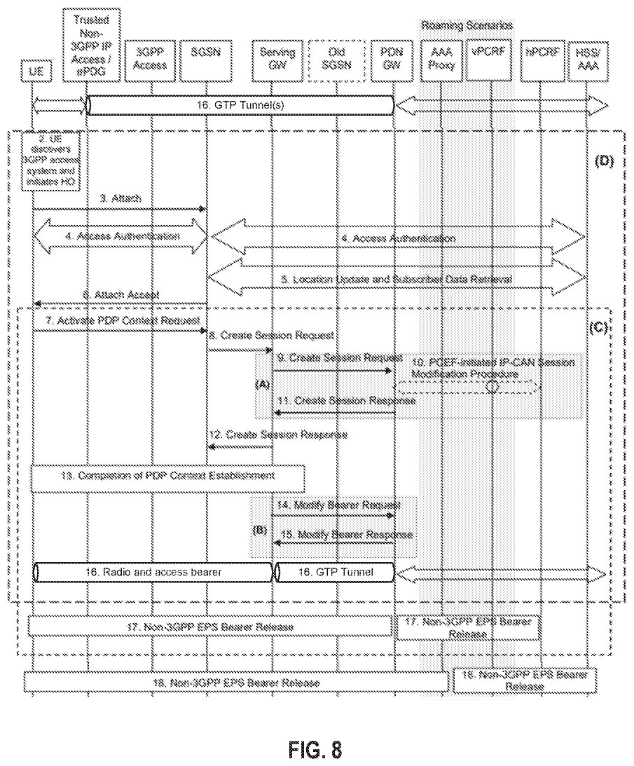

Brief reference is made to FIG. 8, which illustrates IMSI information being used during call setup in the network access identifier (NAI) format. The same information can be passed on for UE identification in the SMO 410. For example, if the IMSI is 234150999999999 (MCC=234, MNC=15), the root NAI then takes the form 0234150999999999@wlan.mnc015.mcc234.3gppnetwork.org.

Referring again to FIG. 5A, if it is determined at block 508 that the RTP packet loss and latency thresholds are not met (i.e., the packet loss is greater than thresh1 and the latency is greater than thresh2), then operations proceed to block 510, and the ePDG 30 performs periodic reporting to the SMO 410.

To handle the information reported by the ePDG 30, the SMO 410 can either utilize non-RT RIC rApps or can use combination of rApp and near-RT RIC xApps. For example, in some embodiments, an SMO 410 rApp may be used for data collection and training purposes, while an xApp may be used for performing inference in near real-time. Communication between rApps and xApps is based on the A1 interface. Thus, at block 512, the SMO 410 may send policy directions to the near-RT RIC 440 via the A1 interface based on the information received from the ePDG 30.

The near-RT RIC 440 contains a UE database and a network database (R-NIB). The SMO 410 can pass UE identification information which the near-RT RIC 440 can use to look up the UE 10 and identify the associated access node (e.g., eNodeB or gNodeB in a 3GPP network).

Once an E2 node associated with the UE 10 is identified, then if the evaluation is done by an xApp, the corresponding E2 node will be asked to share current cell performance information, such as signal strength, RTP packet loss and cell utilization with the Near-RT RIC 440 (block 514). The UE profile is then updated at block 516 with cellular and WiFi performance statistics.

The Near-RT RIC 440 then determines at block 518 whether the cellular voice quality available to the UE 10 is better than the VoWiFi voice quality for the UE. If not, the UE 10 is allowed at block 520 to remain in “WiFi preferred” mode until the next measurement of cellular voice quality and VoWiFi quality. Otherwise, if the cellular voice quality is better than the VoWiFi quality, the Near-RT RIC 440 directs the UE to override the setting of “WiFi preferred” until the next update (block 522).

In case information reporting was immediately notified from the ePDG 30 to the SMO 410 on an urgent basis at block 524, then the SMO 410 will direct an actuation by an xApp, via an rApp and the A1 interface based on the UE identity (block 526). For example, an urgent notification can be identified if the notification is not aligned on periodic triggers from the ePDG 30.

At block 528, the xApp then estimates the voice call quality based on metrics received from the SMO 410 via the E2 interface.

If it is determined at block 528 that the estimated voice quality from VoWiFi is less than a third threshold (CriticalThresh) and the voice quality at VOLTE/VoNR is better than a fourth threshold (Acceptable Thresh), then at block 530, the near-RT RIC 440 can notify the non-14 RT RIC 412 by a feedback mechanism to convey to the SMO 410 that a VoWiFi to VOLTE HO can be initiated. The thresholds CriticalThresh and AcceptableThresh are configurable thresholds.

In another case, where a non-RT RIC 412 determines the VoWiFi quality, then the near-RT RIC 440 will collect the E2 node information and will pass this to the non-RT RIC 412 using the O1 interface. The evaluation mechanism will remain the same, and the SMO 410 will be notified of VoWiFi to VOLTE HO using a SMO service exposure function as shown in FIG. 7.

Referring again to FIG. 5A, at block 532, the SMO 410 then notifies the ePDG 30 to convey to the UE 10 that the cellular access system has better call quality, and that a VoWiFi to VOLTE HO should be initiated. The ePDG 30 will direct the UE 10 to initiate a forced HO from VoWiFi to VoLTE (block 534), which will result in HO as shown in FIG. 8.

The communication between the SMO 410 and the ePDG 30 could be accomplished via a propriety interface, or a new interface. O-RAN has not standardized the implementation of such an interface. As shown in FIG. 7, an EI termination can be used for such communications in an SMO implementation.

A forced HO from VoWiFi to cellular (VOLTE/VoNR) based on voice quality can be achieved, for example, by modifying RAN assistance information (RAI), which contains the cellular access threshold, WLAN access threshold, an offload preference indications.

Referring again to FIG. 5A, some embodiments add voice quality indicator thresholds at RAN and WiFi as Thresh VoiceQualRAN and Thresh Voice QualWiFi. For example, at block 528, a HO for ongoing VoWiFi call will be initiated if Voice Quality at RAN exceeds Thresh VoiceQualRAN and observed voice quality in WiFi is less than Thresh Voice QualWiFi.

Information regarding RAI is transmitted to UEs either in RRC reconfiguration information on in a system information block (SIB).

The threshold Thresh VoiceQualRAN could be greater than or equal to Acceptable Thresh. Similarly, the threshold Thresh VoiceQualWiFi could also be kept equal or greater than the threshold CriticalThresh.

To reduce complexity, the ePDG 30 and the cellular network may also report the estimated voice call quality to the UE 10. The UE 10 may consider this information as observed voice call quality at RAN and WiFi.

In an alternative embodiment, the rApp/xApp operation may also involve the use of a machine learning model(s) to determine the stability of the quality condition described above, based on which the notification is initiated.

This may be done, as opposed to, or in addition with, comparison with configured thresholds. In a case where such a determination involves the use of a machine learning model, suitable time-series forecasting models may be employed to estimate parameters such as packet loss, delay, jitter, signal strength (RSRP), cell load, etc.

These parameters may be collected periodically to train the model to determine an optimal set of model parameters that provide the desired performance in their estimation based on metrics (such as minimum error in prediction). The trained model(s) can then be used to estimate the required parameter.

In yet another alternative embodiment, a Quality of Experience (QoE) metric may also be defined based on a combination of functional knowledge (or domain expertise) and the predicted parameter value(s) obtained from the machine learning model, to determine the nature of stability of quality conditions. Such a parameter may be configured based on operator or performance requirements.

The model may use one or more key performance indicators (KPIs) as input features, including, but not restricted to, RTP packet loss percentage, RTP jitter, RTP latency, RTP gap ratio, RTP session duration, packet data convergence protocol (PDCP) throughput, RLC throughput, physical downlink shared channel (PDSCH) physical resource blocks (PRB), PDSCH bit error ratio (BER), handover indicator, etc.

The model may estimate (forecast) the KPIs through recurrent network architectures that learn time-varying properties of the KPIs. The model may also detect drift in the KPIs to determine (higher) weights (for drifted KPIs, based on domain expertise) for their combination in estimating the QoE metrics.

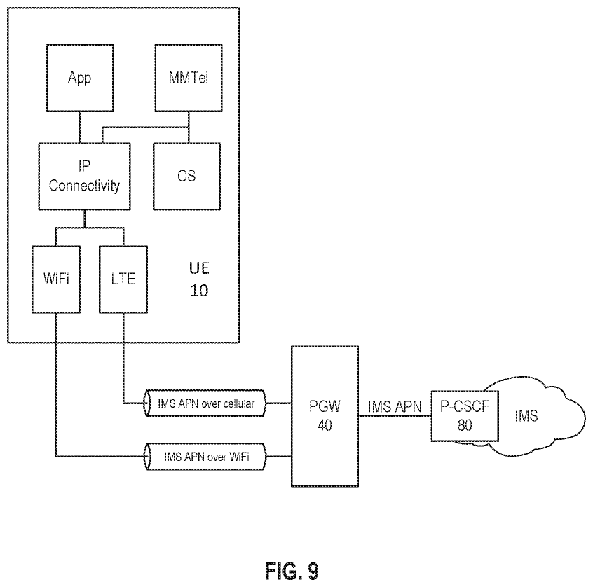

As specified, earlier directed HO is seamless, and the IP address is maintained at handover as shown in FIG. 8. The UE 10 will continue to use cellular access as a preferred state until time indicated by the ePDG 30 in the HO message and will choose LTE for voice as shown in FIG. 9, to which brief reference is made. FIG. 9 illustrates a UE 10 that has an IP voice call managed by an IP telephony application MMTEL. The UE can select either a WiFi based network using a WiFi communication subsystem or an LTE based network using an LTE communication subsystem to carry the call. Both the WiFi subsystem and the LTE subsystem establish IMS APN connections to a packet call session control function (P-CSCF) 80 via a PGW 40. The UE 10 may have a setting to prefer WiFi for IP telephony or to prefer LTE for IP telephony.

The methods described herein impact step 2 from FIG. 8 in which a UE 10 discovers a cellular and initiates a HO. In most of the current deployments, the UE 10 tends to discover cellular (e.g., LTE) only if the WiFi signal strength drops below a certain threshold. In practical scenarios, this occurs when WiFi becomes unavailable. Some embodiments described herein provide a voice quality metric that can be used to prompt the UE 10 to start discovery of a cellular RAT.

The ePDG 30 will discard the session for such UEs for a configurable time. Once the timer expires, the ePDG 30 can either start taking VoWiFi calls from previously listed UEs 10 or it can perform a two-way active measurement protocol (TWAMP) test first to check the link quality.

In either case, the ePDG 30 may share statistics with the SMO 410 as described above, and based on a decision, it may continue the VoWiFi call or can again ask the UE 10 to either not start a VoWiFi connection or to perform a HO to a cellular RAT.

In an alternative embodiment, the operations of an rApp/xApp may also involve the use of a machine learning model(s) to determine the stability of the quality condition described above, based on which the notification is initiated.

This may be done, as opposed to, or in addition with, comparison with configured thresholds. In a case where such a determination involves the use of a machine learning model, suitable time-series forecasting models may be employed to estimate parameters such as packet loss, delay, jitter, signal strength (via reference signal received power, RSRP), cell load, among others.

These parameters may be collected periodically to train the model to determine an optimal set of model parameters that provide the desired performance in their estimation based on metrics (such as minimum error in prediction). The trained model(s) can then be used to estimate the required parameter.

In yet another alternative embodiment, a Quality of Experience (QoE) metric may also be defined based on a combination of functional knowledge (or domain expertise) and the predicted parameter value(s) obtained from the machine learning model, to determine the nature of stability of quality conditions. Such a parameter may be configured based on operator or performance requirements.

The model may use one or more KPIs as input features, including, but not restricted to, RTP Packet Loss Percentage, RTP Jitter, RTP Latency, RTP Gap Ratio, RTP Session Duration, PDCP Throughput, RLC Throughput, PDSCH PRB, PDSCH BER, handover indicator.

The model may involve estimation (forecasting) of these KPIs through recurrent network architectures, that learn time-varying properties of these KPIs. The model may also involve detection of drift in these KPIs to determine (higher) weights (for drifted KPIs, based on domain expertise) for their combination in estimating the QoE metrics (prior art describes feature selection, use of regression model and (weighted) combination to obtain QoE metric).

The model may be trained using KPIs in combination with additional indicators of drift in such KPIs, and voice quality. Baseline for evaluation will be MOS score for training model.

Referring again to FIG. 5A, at block 528, if the criteria Voice Quality at WiFi<CriticalThresh and Voice Quality at VOLTE/VoNR>Acceptable Thresh is not fulfilled, then operations proceed to block 536 of FIG. 5B.

The operations of FIG. 5B make sure that voice quality is not below a critical threshold and certain other thresholds relating to the target cellular network should be met prior to initiating a handover.

If the conditions Signal strength of LTE/5g NR>Thresh3 AND load<Thresh4 AND & packet loss<Thresh5 are met at block 536, then handover notification will be sent from the Near-RT RIC 440 at blocks 540 and 542.

If these conditions are not met, then the call will remain on WiFi and the actuation will be discarded at block 538.

Referring again to FIG. 5A, if conditions RTP packet loss>CriticalThresh1 in a measurement window or latency>CriticalThresh2 are not met at block 508 then it indicates that VoWiFi call link quality is manageable.

In such instances, the ePDG 30 may choose to report statistics at a defined periodicity to the SMO 410 at block 540 if it observes that the link quality has some degradation, even if it is not critically bad.

Such cases can be accounted as Random RTP packet drops in a measurement window>RandThresh or Latency>GoodLatency where RandThresh and GoodLatency are configurable parameters indicating thresholds for packet loss creating bad instances but sustainable during VoWiFi call, and latency which results in good voice call experience.

Once the SMO 410 receives the performance measurement, it can follow the same procedure of passing the enrichment information to the near-RT RIC 440 along with A1 policies from the non-RT-RIC 412 via the A1 interface at blocks 512 and 514, which can dictate the actions. The Near RT RIC 440 would subscribe for E2 performance measurements related to signal strength, packet loss, latency, jitter, etc. It will continue to evaluate the link quality based on current conditions as well as forecasted conditions for the 95th percentile of predicted call durations.

The predicted call duration may also be determined using a data-driven approach that may use a machine learning model to estimate the call duration based on parameters. Such a model may be a regression model that estimates the call duration as a function of other dependent variables (parameters), or it may also be a recurrent model that incorporates the timestamps of these parameter measurements to determine the call duration.

Examples of such parameters may include RTP packet sequence number, average package loss, delay, jitter, burst ratio, or their statistically aggregated representations.

The model may be trained initially on these available parameters, and their parameters may be updated when more data is available, to improve the performance of the model in estimating the call duration.

If at block 518, the LTE access performance is found to be better for a certain window, then feedback will be passed to the ePDG 30 via the SMO 410 from the non-RT RIC 412 for a forced HO from WiFi to cellular, which in the case of 3GPP will proceed as described in FIG. 7.

If during the evaluation to decide whether immediate reporting or periodic reporting should be used, if the cellular link quality does not meet the defined thresholds, then the VoWiFi call will be retained at block 520.

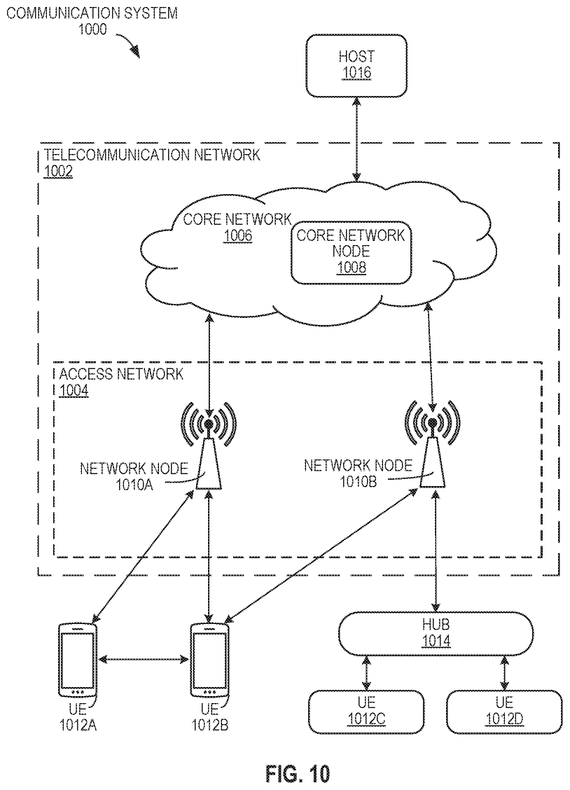

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3rd Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single-or multi-RAT or multi-standard mode. For example, a UE may operate with any one or combination of WiFi, NR (New Radio) and LTE, i.e. being configured for multi-radio dual connectivity (MR-DC), such as Evolved-Universal Mobile Telecommunication System Terrestrial Radio Access Network (E-UTRAN) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub-that is, a hub whose primary function is to route communications to/from the UEs from/to the network node 1010b. In other embodiments, the hub 1014 may be a non-dedicated hub-that is, a device which is capable of operating to route communications between the UEs and network node 1010b, but which is additionally capable of operating as a communication start and/or end point for certain data channels.

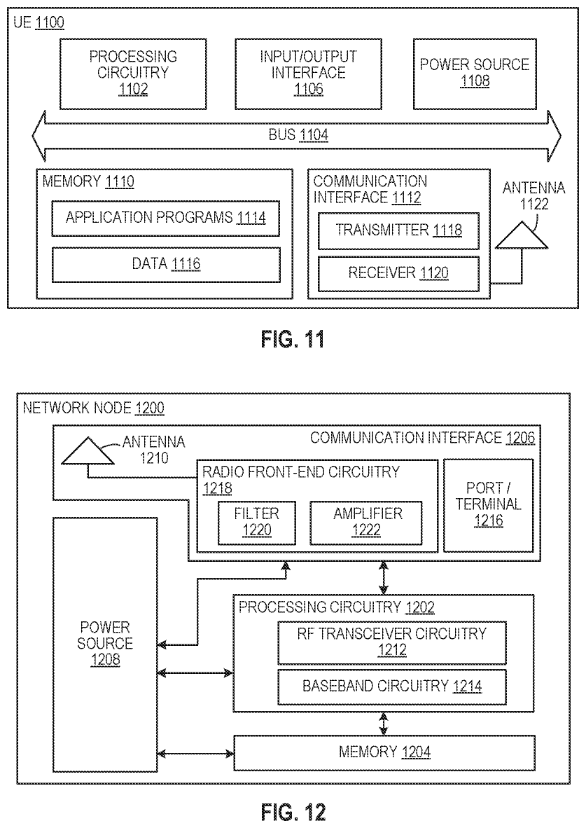

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, WiFi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

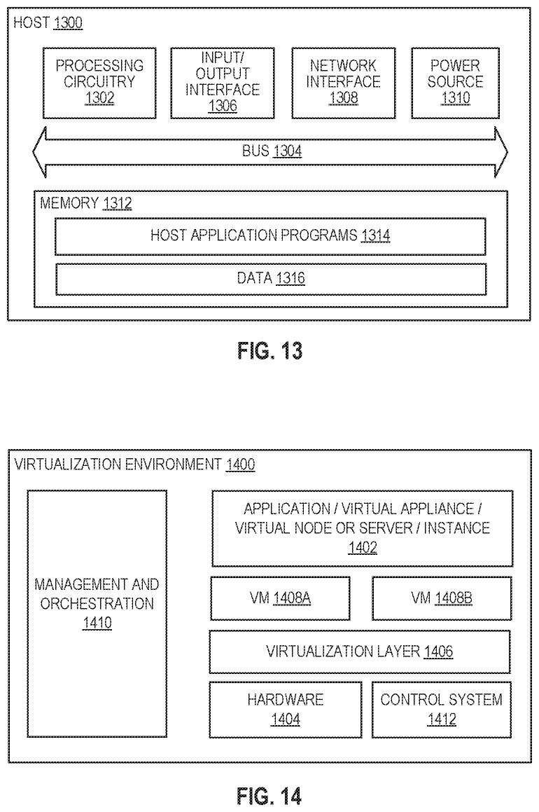

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

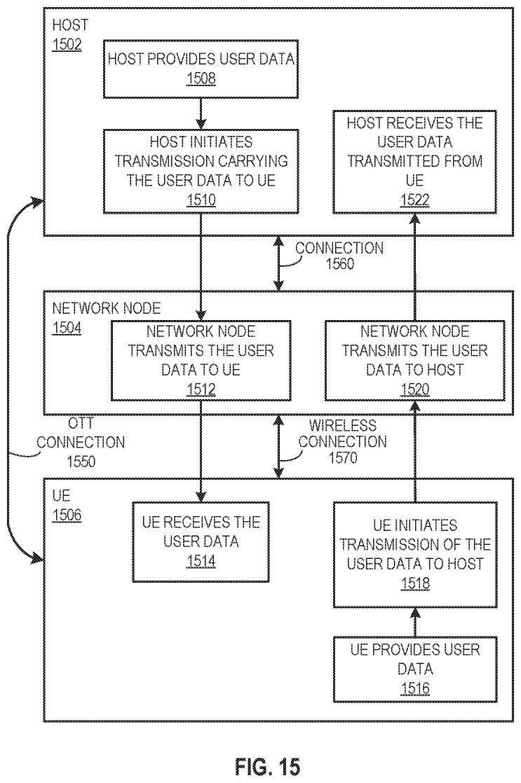

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc. ; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein.

Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method by a core network function of a core network of a wireless communication network, comprising:
detecting that a user equipment, UE, that is connected to the wireless communication network is using an unlicensed radio access network to access an internet protocol media subsystem, IMS, voice telephony service using a packet data connection with a packet gateway in the wireless communication network; and
monitoring a quality measurement of a voice connection of the UE that uses the packet data connection that is established over the unlicensed radio access network.

2. The method of claim 1, further comprising:
determining whether the quality measurement of the voice connection indicates that the voice connection has a low quality of service; and
in response to determining that the voice connection has a low quality of service, reporting to a cellular radio access network in the wireless communication network that the voice connection has the low quality of service.

3. The method of claim 1, further comprising:
receiving an indication from the radio access network that the UE should perform a handover of the voice connection to the cellular radio access network; and
in response to the indication, requesting that the UE handover the voice connection to the cellular radio access network.

4. The method of claim 1, wherein reporting to the cellular radio access network in the wireless communication network that the voice connection has the low quality of service comprises reporting to a service management and orchestration function in the wireless communication network.

5. The method of claim 1, further comprising:
determining whether the quality measurement of the voice connection indicates that the voice connection has a low quality of service; and
in response to determining that the voice connection does not have a low quality of service,
periodically reporting information relating to the quality of service of the voice connection to a cellular radio access network in the wireless communication network.

6. The method of claim 1, wherein monitoring the quality measurement of a voice connection of the UE that uses the packet data connection that is established over the unlicensed radio access network comprises monitoring a first quality measure and a second quality measure and comparing the first quality measure to a first threshold and the second quality measure to a second threshold.

7. A method by a service management and orchestration entity that performs management of a radio access network, the method comprising:
receiving, from a core network function of a core network, information regarding a call quality of a voice connection of a user equipment, UE, that is connected to the radio access network, wherein the voice connection uses an unlicensed radio access network to access an internet protocol media subsystem, IMS, voice telephony service using a packet data connection with a packet gateway in the core network that carries the voice connection; and
determining whether or not to request a handover of the voice connection to the radio access network in response to the information.

8. The method of claim 7, wherein determining whether or not to request a handover of the voice connection to the radio access network comprises determining whether the quality of the voice connection is less than a critical threshold quality level.

9. The method of claim 8, wherein determining whether or not to request a handover of the voice connection to the radio access network further comprises determining whether an expected quality of the voice connection after handover to the radio access network is greater than an acceptable threshold quality level.

10. The method of claim 7, further comprising:
transmitting an indication to the core network function that the UE should handover the voice connection to the radio access network.

11. The method of claim 7, further comprising, in response to receiving the information, subscribing to call quality information relating to the call; and
continuing to monitor the call quality of the voice connection.

12. The method of claim 11, further comprising:
instructing the UE to override a setting of “always prefer WiFi to cellular” for packet data voice connections in response to the call quality of the voice connection.

13. The method of claim 12, further comprising:
in response to determining that the quality of the voice connection is greater than the critical threshold quality level or determining that the expected quality of the voice connection after handover to the radio access network is less than the acceptable threshold quality level, comparing a signal strength of a signal transmitted from the radio access network to the UE to a third threshold; and
in response to determining that the signal strength of the signal transmitted from the radio access network to the UE is less than the third threshold, allowing the UE to continue the voice connection using the unlicensed radio access network.

14. The method of claim 13, further comprising:
in response to determining that the signal strength of the signal transmitted from the radio access network to the UE is greater than the third threshold, transmitting an indication to the core network function of the core network to cause the UE to handover the voice connection to the radio access network.

15. The method of claim 13, further comprising comparing a load measure of the voice connection over the unlicensed radio access network to a fourth threshold and comparing a packet loss measure of the voice connection over the unlicensed radio access network to a fifth threshold, the method further comprising:
in response to determining that the signal strength of the signal transmitted from the radio access network to the UE is greater than the third threshold, that the load measure is lower than the fourth threshold, and that the packet loss measure is lower than the fifth threshold, transmitting an indication to the core network function of the core network to cause the UE to handover the voice connection to the radio access network.

16. A wireless communication system, comprising:
a core network function of a core network of the wireless communication system, and a service management and orchestration, SMO, entity that manages a radio access network of the wireless communication system;
wherein the core network function:
detects that a user equipment, UE, that is connected to a radio access network of the wireless communication network is using an unlicensed radio access network to access an internet protocol media subsystem, IMS, voice telephony service using a packet data connection with a packet gateway in the core network;
monitors a quality measurement of a voice connection of the UE that uses the packet data connection that is established over the unlicensed radio access network.
determines whether the quality measurement of the voice connection indicates that the voice connection has a low quality of service; and
in response to determining that the voice connection has a low quality of service, reports to a cellular radio access network in the wireless communication network that the voice connection has the low quality of service; and
wherein the SMO:
receives, from the core network function, an indication that the voice connection has the low quality of service; and
determines whether or not to request a handover of the voice connection to the radio access network in response to the indication.

17. A network node, comprising:
processing circuitry configured to perform any of the steps of claim 1; and
power supply circuitry configured to supply power to the processing circuitry.
